(19) United States
(12) Patent Application Publication
(10) Pub. No.: US 2003/0206739 A1
(43) Pub. Date: Nov. 6, 2003

(54) Audio/video IP camera

(76) Inventor: Kun-Shan Lu, Taipei (TW)

Correspondence Address: J.C. Patents, Inc., Suite 250, 4 Venture, Irvine, CA, 92618, US

(21) Appl. No.: 09/945,288

(22) Filed: Aug. 30, 2001

(30) Foreign Application Priority Data
Jul. 4, 2000 (TW) 90116328

(51) Int. Cl. G03B 17/48

(52) U.S. Cl. 396/429

(57) ABSTRACT

An audio/video IP camera having a digital video unit, a digital audio unit, a system control user interface and a digital audio/video processor. The digital video unit generates digital video data and the digital audio unit generates digital audio data. The system control user interface controls the camera. The digital audio/video processor connects with the digital video unit, the digital audio unit and the system control user interface for processing audio/video data synchronously and transmitting the data to a monitoring terminal in real time via a network. The monitoring terminal registers the audio/video data using a digital camera or broadcasts the synchronous audio/video data through a web browser.

### BACKGROUND OF THE INVENTION

1. Field of Invention

The present invention relates to an audio/video IP camera. More particularly, the present invention relates to an audio/video camera capable of digitizing audio/video signals and synchronizing the transmission of digitized signals via a network.

2. Description of Related Art

In this information explosion era, knowledge is spread from place to place via a network of video and audio signals. Due to the breakthrough in digital processing, audio/video data are no longer constrained to a particular media, resulting in relatively high transmission stability. To meet our requirements in the digital era, various types of digital products have been developed. Examples include the digital cameral, digital camera, MP3 player and DVD player. By connecting the digital equipment with a computer, digital data from the digital equipment may be modified. Moreover, operation of the digital equipment may be monitored through the computer as well. For example, through an interface between a digital camera and a computer, the computer may control the operation of the digital camera. In addition, images captured by the digital camera may be modified via the image interface.

In recent years, telecommunication services have increased so rapidly, due to rapid development of the world wide web (WWW), that distance constraints between computers have been virtually wiped out. Nowadays, network data transmission is no longer restricted to the transmission of textual data but includes multimedia network transmission. Since digital electronic products can easily link up with a network, audio/video data may transmit to every corner of the network. Static or dynamic images captured by a camera may be transmitted to various locations in the network using communication protocols such as HTTP or HTML. In a similar way, the camera may be controlled through a network browser.

However, current cameras produce only video output. Audio output is generally absent. To produce audio output, a microphone is frequently attached to the camera. With this arrangement, length of the output cable is limited (not exceeding 6 meters). Hence, digitized audio/video signals cannot conduct a synchronous real time data transmission without distance limitations.

### SUMMARY OF THE INVENTION

Accordingly, one object of the present invention is to provide an audio/video IP camera capable of digitizing audio/video signals and conducting unrestricted synchronous transmission through a network.

A second object of this invention is to provide an audio/video IP camera having a digital video unit for generating digital image data, a digital audio unit for generating digital audio data and a digital audio/video processor. By connecting the digital audio/video processor, the digital video unit and the digital audio unit, synchronous processing of audio/video data can be conducted with the resulting data transmitted in real-time to a remote control terminal via a network. The audio/video data is recorded in a digital recorder. Alternatively, the audio/video data is transmitted synchronously from a network browser.

To achieve these and other advantages and in accordance with the purpose of the invention, as embodied and broadly described herein, the invention provides an audio/video IP camera. The camera includes a digital video unit, a digital audio unit, a system control user interface and a digital audio/video processor. The digital video unit outputs digital image data captured by the camera. The digital audio unit is coupled to the digital video unit for outputting digital audio data captured by the camera. The system control user interface provides the user with control instructions for tilting, panning and zooming of the camera. The digital audio/video processor couples with the digital video unit, the digital audio unit and the system control user interface.

The digital audio/video processor further includes a compression module, a signaling module, a real-time transport protocol and a local area network interface. The compression module couples with the digital video unit for compressing digital video data from the digital video unit. The signaling module couples with the system control user interface for compressing control instructions from the system control user interface. The real-time transport couples with the compression module and the digital audio unit for processing the digital video data and the digital audio data synchronously and producing a synchronous digital audio/video data. The local area network interface couples with the real-time transport protocol and the signaling module. The local area network interface facilitates the output of synchronous digital audio/video data from the network interface according to currently developed network links.

This invention utilizes the real-time transport protocol and related communication protocol within the digital audio/video processor to compress the digital audio/video data captured by a camera and sequence the audio/video data synchronously. The digital audio/video data are output via a local area network interface. The camera is also linked to a remote control terminal via the world wide web so that the real-time audio/video data captured by the camera can be stored or re-transmitted elsewhere from a network browser. In addition, the audio/video IP camera of this invention is capable of real-time transmission via a network. Hence, the invention can be applied to intercom services or other synchronous audio/video transmission devices.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic diagram showing an audio/video IP camera system according to one preferred embodiment of this invention;

FIG. 2 is a schematic diagram showing the digital audio/video processor inside the audio/video IP camera shown in FIG. 1;

FIG. 3 is a schematic diagram showing a network configuration for the audio/video IP camera system according to this invention; and

FIG. 4 is a schematic diagram showing the network configuration of an audio/video intercom system according to this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

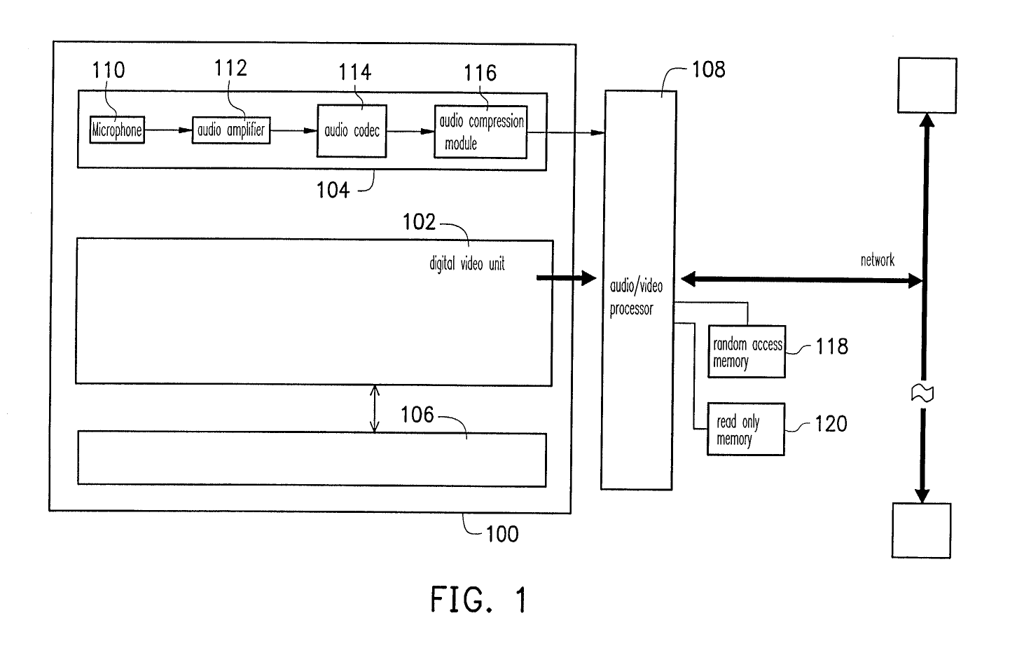

FIG. 1 is a schematic diagram showing an audio/video IP camera system according to one preferred embodiment of this invention. The audio/video IP camera 100 includes a digital video unit 102, a digital audio unit 104, a system control user interface 106 and a digital audio/video processor 108. The digital video unit 102 generates digital image data and the digital audio unit 104 generates digital speech data. The system control user interface 106 controls tilting, panning and zooming of the camera. The digital audio/video processor 108 processes video and audio data synchronously and outputs processed data through a network interface.

The digital video unit 102 further includes a digital signal processor (not shown in FIG. 1) for digitizing raw image data captured by the camera 100 and producing digital video data. By connecting the digital video unit 102 and the digital audio/video processor 108, digital image data is fed into the digital audio/video processor 108 so that forthcoming digital audio data can be processed synchronously. The synchronously processed data is able to transmit to far off places via a network. In addition, a random access memory (RAM) unit 118 and a read-only-memory (ROM) unit 120 are coupled to the audio/video processor 108 for holding data temporarily so that special application programs can be used to process the data.

Digital audio data captured by the camera 100 is generated through the digital audio unit 104. As shown in FIG. 1, the digital audio unit 104 includes a microphone 110, an audio amplifier 112, an audio codec 114 and a speech compression module 116. The microphone 110 converts physical vibration into an electrical signal. The electrical signal is amplified inside the audio amplifier 112. The amplified electrical signal is decoded and encoded by the audio codec 114. Because the audio data file needed to hold the electrical signal is too large, audio data needs to be compressed by the audio compression module 116. For example, using a wav audio file, a digital audio packet is ultimately produced. The method of compressing audio data is based on the G.723 standard proposed by the International Telecommunication Union (ITU).

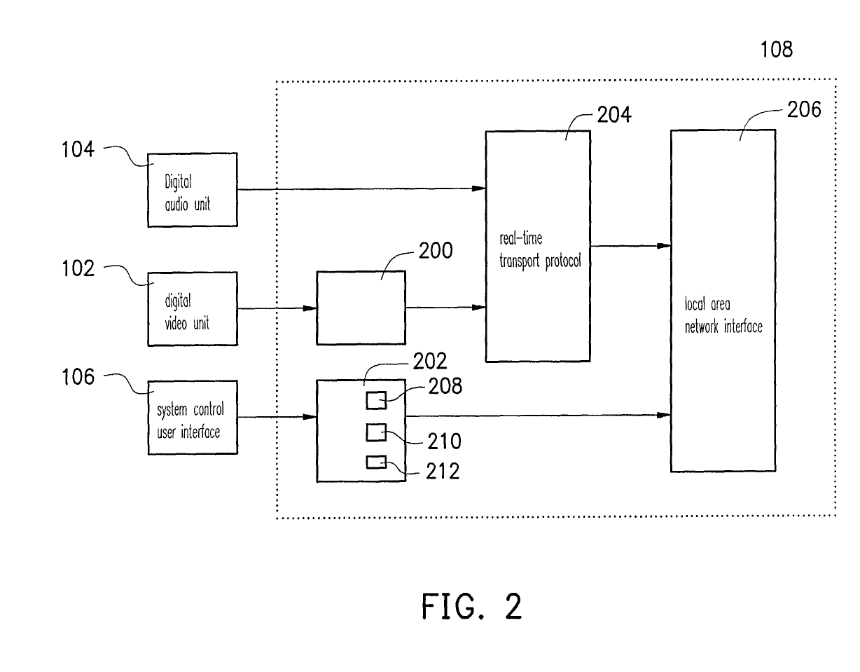

FIG. 2 is a schematic diagram showing the digital audio/video processor inside the audio/video IP camera shown in FIG. 1. As shown in FIG. 2, the digital audio/video processor 108 further includes a video compression module 200, a signaling module 202, a real-time transport protocol (RTP) 204 and a local area network (LAN) interface 206. The digital video unit 102 and the video compression module 200 are connected together so that digital image data can feed into the video compression module 200 to carry out video data compression. Although the digital video data provided by the digital video unit 102 might be compressed using any one of the video compression standards recommended by the ITU, the preferred video compression standard is the H.263 standard. Using the H.263 standard, digital video data can be encoded and decoded to generate a digital video packet. Furthermore, in this embodiment, although the video compression module 200 is enclosed within the digital audio/video processor 108, the video compression module 200 can also be a built-in unit within the digital video unit 102.

The real-time transport protocol (RTP) 204 provides an end-to-end network transmission function suitable for broadcasting real-time data such as audio, video and simulated data through a network. Through the interconnections of the real-time transport protocol 204, the digital audio unit 104 and the video compression module 200, compressed digital video data packet and compressed digital audio data packet are fed to the real-time transport protocol 204 for synchronous processing. Different data packets are sequenced inside the real-time transport protocol 204 to produce real-time audio/video data. In addition, the real-time transport protocol 204 has a real-time control protocol (RTCP) capable of utilizing quality of distribution of feedback data to speed up data transmission, controlling multiple terminal data transmission and providing minimal control and identification. Although a real-time transport protocol is used in this invention to carry out synchronous processing of digital video and digital audio data, any related protocols capable of conducting synchronous processing of video data and audio data are within the scope of this invention.

The signaling module 202 of this invention uses a signaling protocol proposed by the ITU. This includes a network control protocol 208. For example, RAS (registration, admission, status) also known as gatekeeper is capable of registering, admitting and controlling status through the provision of channels for transmitting messages and managing transmitted data while Q.931 manages communication settings and termination. The signaling module 202 further includes a session control protocol 210 such as H.245. H.245 synchronizes the use of transmission channels, controls data flow and transmits general instructions and permits line transmission of non-telephone signals. The signaling module 202 also includes a hyper-text transfer protocol (HTTP) 212 that provides data and instruction transmission between a world wide web (WWW) browser and a WWW server. However, this invention is not limited by the aforementioned communication protocols. Any related communication protocols capable of managing real-time transmission of digital video data and digital audio data is within the scope of this invention.

When the system control user interface 106 submits an instruction for performing a specific camera function to the signaling module 202, the camera 100 can be monitored through a network using the aforementioned network control protocol 208, session control protocol 210 and hypertext transfer protocol 212. By integrating with the real-time transport protocol 204, a controlled transmission of digital audio/video data to remote locations via the network is possible. Furthermore, through the world wide web, the synchronously processed digital audio/video data is transmitted from the local area network interface 206 to other locations.

In general, digital audio/video data is transmitted to other locations through an integrated service digital network (ISDN), T1 carrier lines and modems. However, an ordinary phone line may also be used to carry the digital audio/video data, creating the so-called phone video. Other types of network connecting methods such as an asymmetrical digital subscribe line (ADSL) or a broadband network may be used for transmitting digital audio/video data as well.

Because the audio/video IP camera of this invention is able to transmit real-time audio/video data through a network, the camera has applications in different types of network arrangements.

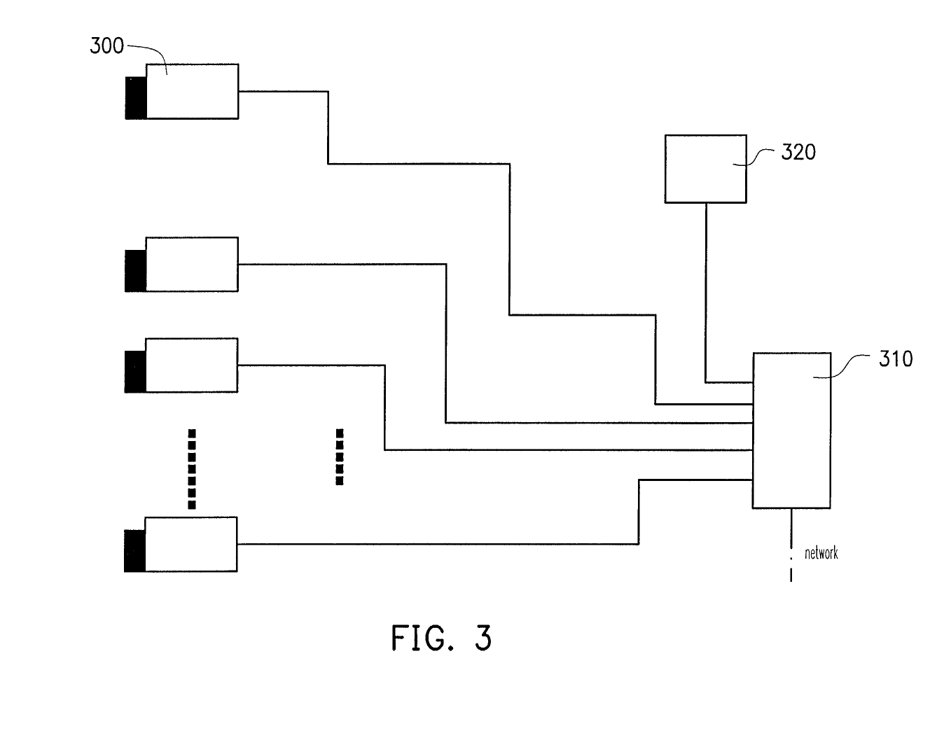

FIG. 3 is a schematic diagram showing a network configuration for the audio/video IP camera system according to this invention. As shown in FIG. 3, a plurality of individual network cameras 300 is connected to a hub 310. Due to the positioning of cameras 300 in different locations, different real-time audio/video data are captured by each camera 300. Through the hub 310 and a router (not shown in FIG. 3), the cameras 300 are connected to other monitoring terminals 320 via a network. Thus, users at different monitoring terminals 320 are able to capture required audio/video data for their specific applications. For example, if the monitoring terminal 320 is a standalone digital video recorder (S-DVR), a user may record the real-time audio/video data. On the other hand, if the monitoring terminal 320 is a computer terminal having a web browser function, a user may initiate a synchronized broadcasting so that the user may watch in real time sound and images captured by the remote camera.

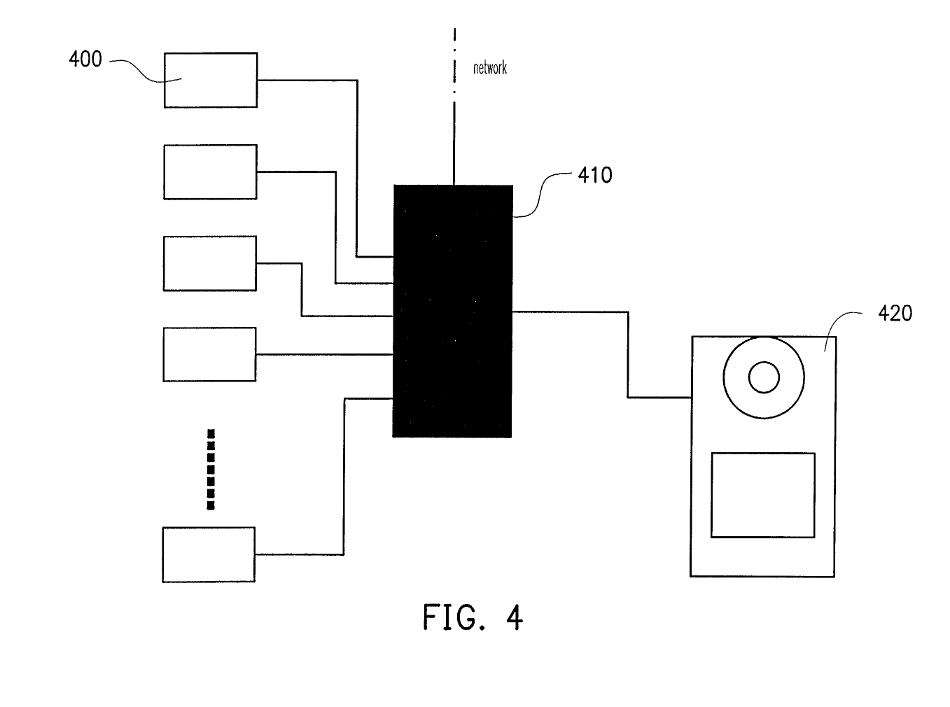

FIG. 4 is a schematic diagram showing the network configuration of an audio/video intercom system according to this invention. As shown in FIG. 4, the system includes an audio/video network intercom 420, a hub 410 and a plurality of indoor display monitors 400. The audio/video network intercom 420 is connected to the plurality of indoor display monitors 400 through a network. Since the audio/video IP camera of this invention can provide necessary monitoring function to a user via the network, the system is suitable for connecting up audio/video intercoms located in different regions. For example, when the audio/video IP camera inside the intercom 420 is triggered, captured audio/video data is transmitted via the network to the indoor display monitor 400 so that sound and images at that particular location are displayed in real time. This type of system is particular useful in security management.

In summary, this invention utilizes the real-time transport protocol and related communication protocols inside the digital audio/video processor to compress/decompress and to process the digital audio/video data captured by a camera synchronously. The digital audio/video data is output from the local area network interface. The interface connects with a network so that the camera is actually linked to a remote monitoring terminal. Hence, the remote monitoring terminal may download the real-time data captured by the camera or play out the sound and images immediately through a web browser. In addition, because the audio/video IP camera can conduct real-time data transmission through a network, the camera can be used in intercom or various other systems such as devices requiring remote synchronous audio/video transmission. The audio/video IP camera may be further developed into a bi-directional audio/video transmission network such that various terminals connected to the network may transmit audio and video data to each other.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An audio/video IP camera, comprising:
a digital video unit for outputting digital video data captured by the camera;
a digital audio unit for outputting digital audio data captured by the camera;
a system control user interface for providing user with a set of instructions that controls the tilting, panning and focusing of the camera; and
a digital audio/video processor connected to the digital video unit, the digital audio unit and the system control user interface, wherein the digital audio/video processor further includes:
a real-time transport protocol connected to a compression module and the digital audio unit for processing the digital video data and the digital audio data and producing synchronous digital audio/video data.

2. The camera of claim 1, wherein the digital audio/video processor further includes a local area network interface connected to the real-time transport protocol and a signaling module such that synchronous digital audio/video data can be transmitted to remote terminals through the network interface.

3. The camera of claim 2, wherein the local area network interface and the digital audio/video camera are connected so that synchronous audio/video data can be registered by the digital audio/video camera through the network.

4. The camera of claim 2, wherein the local area network interface and a computer terminal are connected together so that the synchronous digital audio/video data can be broadcast through a network browser.

5. The camera of claim 1, wherein the digital audio unit further includes a microphone, an audio amplifier, an audio codec and a speech compression module.

6. The camera of claim 1, wherein the digital video unit further includes a digital signal processor.

7. The camera of claim 1, wherein the audio/video IP camera further includes an audio/video network intercom.

8. The camera of claim 7, wherein the audio/video network intercom is connected to an indoor display monitor through a network connection port.

9. The camera of claim 1, wherein the digital audio/video processor further includes a compression module connected to the digital video unit so that digital video data provided by the digital video unit is compressed.

10. The camera of claim 1, wherein the digital audio/video processor further includes a signaling module connected to the system control user interface for providing control instructions to the system control user interface and controlling the transmission of digital video data and digital audio data.

11. An audio/video IP camera, comprising:
a digital video unit for outputting digital video data;
a digital audio unit for outputting digital audio data;
a system control user interface for outputting control instructions; and
a digital audio/video processor, comprising:
a real-time transport protocol for receiving the digital video data and the digital audio data; and
a local area network interface.

12. The camera of claim 11, wherein the local area network interface connects with a digital audio/video camera so that synchronized digital audio/video data from the digital audio/video camera can be stored via a network.

13. The camera of claim 11, wherein the local area network interface connects with a computer terminal so that the synchronized digital audio/video data can be broadcast via a network browser.

14. The camera of claim 11, wherein the digital audio unit further includes a microphone, an audio amplifier, an audio codec and an audio compression module.

15. The camera of claim 11, wherein the digital video unit further includes a digital signal processor and a video compression module.

16. The camera of claim 11, wherein the audio/video IP camera further includes an audio/video network intercom.

17. The camera of claim 16, wherein the audio/video network intercom is connected to an indoor display monitor through a hub.

18. An audio/video IP camera recording method, comprising the steps of:
feeding video data and audio data into a transport protocol unit so that the video data and the audio data are synchronously processed to produce real-time audio/video data; and
transmitting the real-time audio/video data to a local area network interface so that the real-time audio/video data can be transmitted to remote locations through a network.

19. The method of claim 18, wherein the transport protocol includes a real-time transport protocol.

20. The method of claim 18, wherein the real-time audio/video data may be broadcast via a web browser.
